(19) United States
(12) Patent Application Publication
(10) Pub. No.: US 2009/0041458 A1
(43) Pub. Date: Feb. 12, 2009

(54) PASSIVE OPTICAL NETWORK SYSTEM MANAGEMENT

(76) Inventor: QING LIN, San Jose, CA (US)

Correspondence Address: IPSG, P.C., P.O. BOX 700640, SAN JOSE, CA, 95170, US

(21) Appl. No.: 11/934,003

(22) Filed: Nov. 1, 2007

Related U.S. Application Data
(60) Provisional application No. 60/864,134, filed on Nov. 2, 2006.

(51) Int. Cl. H04J 14/00

(52) U.S. Cl. 398/58

(57) ABSTRACT

A passive optical network (PON) system utilizing a data link layer protocol for communication is disclosed. The PON system may include an optical network unit (ONU). The PON system may also include an optical line terminal (OLT) configured to communicate with the ONU utilizing an Ethernet frame. The Ethernet frame may include at least a source application identifier and a destination application identifier. The source application identifier may represent a source application residing in at least one of the OLT and the ONU. The destination application identifier may represent one or more destination applications configured to receive data from the source application.

The present invention claims priority under 35 USC 119(e) to a commonly owned provisionally filed patent application entitled “PASSIVE OPTICAL NETWORK SYSTEM MANAGEMENT,” U.S. Application No. 60/864,134, Attorney Docket No. OBRB-P001P1, filed Nov. 2, 2006 by inventor Qing Lin, which is incorporated herein by reference.

### BACKGROUND OF THE INVENTION

In communication systems, optical access systems offer a potentially large bandwidth as compared with copper-based access systems. A broadband optical access system may be utilized, for example, to distribute a variety of broadband and narrowband communication services from a service provider's facility to a local distribution point and/or directly to the customer premises. These communication services may include telephony (e.g. POTS, VoIP, and VoATM), data (e.g. ISDN, and Ethernet), and/or video/audio (e.g. television, CATV, PPV, and VoD) services.

In optical access systems, a passive optical network (PON) system, such as an Ethernet passive optical network (EPON) system, is typically a point-to-multiple point system that may include one optical line terminal (OLT) coupled to multiple optical network units (ONUs), including one or more dummy ONUs and/or one or more intelligent ONUs, as illustrated in FIG. 1.

FIG. 1 illustrates an example EPON system 100. EPON system 100 may include an OLT 132, a dummy ONU 102, and an intelligent ONU 130. OLT 132 may be coupled to dummy ONU 102 and intelligent ONU 130 through a splitter 150. OLT 132 may include an OLT host CPU 134 to support fault, configuration, accounting, performance, and security functions (FCAPS) for operation, administration, and management (OAM) of dummy ONU 102, intelligent ONU 130, and other ONUs. Intelligent ONU 130 may include an ONU host CPU 104 for managing additional hardware such as a switch, LEDs, etc. or perform additional functions, for example, through applications executed by a third-party chipset 106.

OLT 132, dummy ONU 102, and intelligent ONU 130 may include IEEE 802.3ah based EPON MAC chipsets 105, 107, and 108 that provide interface for OLT 132 to perform operation, administration, management, and provision (OAMP) pertaining to ONUs 130 and 102. However, EPON MAC chipsets 105 and 108 may not provide interface for OLT host CPU 134 to communicate with ONU host CPU 104 for host CPU 134 to control intelligent ONU 130 in managing the above mentioned additional hardware and in performing the above mentioned additional functions. Further, ONU host CPU 104 may not be able to control OLT host CPU 134 to execute applications run on third-party chipset 111 in OLT 132.

There is no standard solution for providing a communication channel between OLT host CPU 134 and ONU host CPU 104 for controlling the additional hardware and functions. A prior-art solution is to utilize a TCP or UDP socket as a communication channel between OLT host CPU 134 and ONU host CPU 104. However, the prior-art solution may require implementing a TCP/IP stack, and the overhead for setting up a reliable communication may be disadvantageously large. The prior-art solution may also need to assign an IP address to each of OLT 132 and ONU 130, which have only port MAC addresses, and therefore may disadvantageously consume IP address resource. In addition, IP addresses are associated with a network layer (or layer 3), which is not natural to an EPON system, which is a data link layer (or layer 2) system.

### SUMMARY

An embodiment of the present invention relates to a passive optical network (PON) system utilizing a data link layer protocol for communication. The PON system may include an optical network unit (ONU). The PON system may also include an optical line terminal (OLT) configured to communicate with the ONU utilizing an Ethernet frame. The Ethernet frame may include at least a source application identifier and a destination application identifier. The source application identifier may represent a source application residing in at least one of the OLT and the ONU. The destination application identifier may represent one or more destination applications configured to receive data from the source application.

The above summary relates to only one of the many embodiments of the invention disclosed herein and is not intended to limit the scope of the invention, which is set forth is the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements in which:

FIG. 1 illustrates a schematic representation of an example EPON system.

FIG. 2A illustrates a schematic representation of a typical Ethernet frame format.

FIG. 2B illustrates a schematic representation of an Ethernet frame format for facilitating management of an EPON system in accordance with one or more embodiments of the present invention.

FIG. 3 illustrates a schematic representation of system software architecture of an EPON system in accordance with one or more embodiments of the present invention.

FIG. 4A illustrates a schematic representation of an application interface function format for transmitting a message in an asynchronized (or asynchronous) mode in accordance with one or more embodiments of the present invention.

FIG. 4B illustrates a schematic representation of an application interface function format for transmitting a message in a synchronized (or synchronous) mode in accordance with one or more embodiments of the present invention.

FIG. 5 illustrates a flowchart of a method for a receiver to process a message in accordance with one or more embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

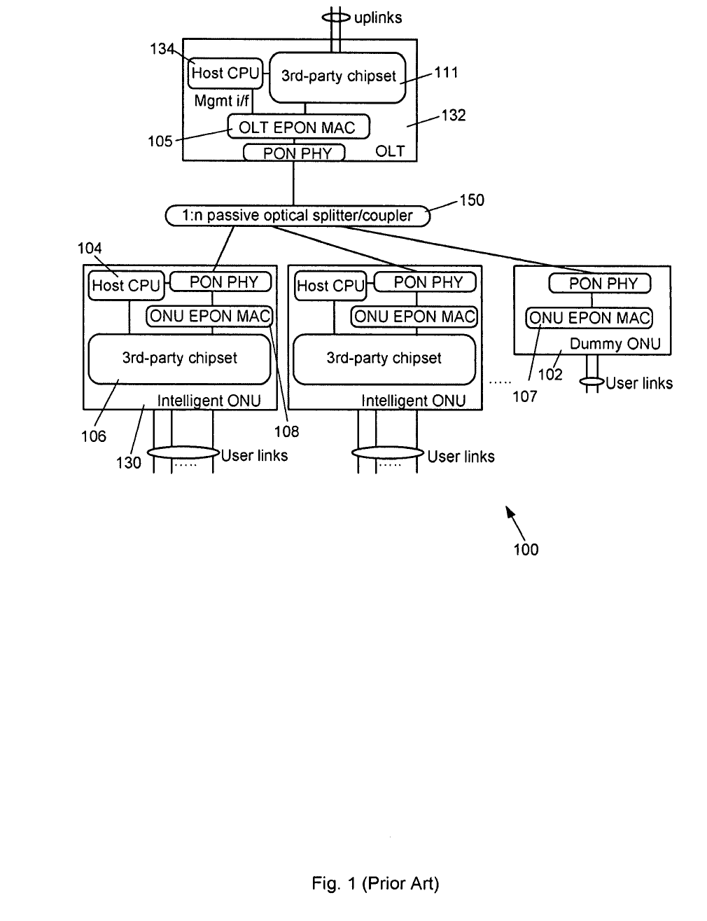

One or more embodiments of the present invention involve utilizing an Ethernet frame, i.e., a data link layer (or layer 2) protocol, for providing a communication channel between an OLT host CPU, e.g., similar to OLT host CPU 134 illustrated in the example of FIG. 1, and one or mole ONU host CPUs, e.g., similar to ONU host CPU 104 illustrated in the example of FIG. 1, in a PON system, such as a layer 2 EPON system.

One or more embodiments of the invention relate to an Ethernet frame for facilitating communication. The Ethernet frame may include a source application identifier representing a source application. The source application may reside in at least one of an optical line terminal (OLT) and an optical network unit (ONU) in a passive optical network (PON) system. The Ethernet frame may also include a destination application identifier representing one or more destination applications. The one or more destination applications may be configured to receive data from the source application. For example, The destination identifier may represent all of a plurality of applications in a destination node, which may represent the OLT, the ONU, or a plurality of ONUs.

The Ethernet frame may also include an application level message identifier. The application level message identifier may have a first byte configured to represent one or more requests and/or one or more replies. The application level message identifier further may also have a second byte configured to specify an object and/or an attribute for the one or more destination applications to operate on.

The Ethernet frame may also include a return code configured for the one or more destination applications to return status information to the source application.

One or more embodiments of the invention relate to a PON system utilizing a data link layer protocol for communication. The PON system may include an ONU. The PON system may also include an OLT configured to communicate with the ONU utilizing an Ethernet frame. The Ethernet frame may include at least a source application identifier and a destination application identifier. The source application identifier may represent a source application residing in at least one of the OLT and the ONU. The destination application identifier may represent one or more destination applications configured to receive data from the source application.

The PON system may also include a sender program residing in the at least one of the OLT and the ONU. The sender program may be configured to pack the data in the Ethernet frame. The sender program may also be configured to send the Ethernet frame through a passive optical network.

The sender may also be configured to provide an application interface for the source application to transmit the data. The application interface may include at least a pointer pointing to at least one of an application payload and an application level message identifier in the Ethernet frame.

In one or more embodiments, the data may be transmitted in an asynchronized (asynchronous) mode. The source application may be configured to place a reply from the one or more destination applications in a message queue of the source application if the source application receives the reply from the one or more destination applications.

In one or more embodiments, the application interface may also be configured for the one or more destination applications to send a reply to the source application. The reply may be contained in a second Ethernet frame having a modified message identifier that is modified based on a message identifier of the Ethernet frame.

The PON system may also include a receiver program configured to unpack the Ethernet frame to obtain the data and/or a pointer pointing to the data. The receiver program may also be configured to dispatch the data and/or the pointer pointing to the data to the one or more destination applications.

One or more embodiments of the invention relate to a method for facilitating communication between an OLT and ONU in a PON system. The method may include receiving data from a source application, the source application residing in at least one of the OLT and the ONU. The method may also include packing the data in an Ethernet frame. The Ethernet frame may include at least a source application identifier representing the source application. The Ethernet frame may also include at least a destination application identifier representing one or more destination applications. The method may also include sending the Ethernet frame.

The method may also include unpacking the Ethernet frame to obtain the data and/or a pointer pointing to the data. The method may also include dispatching the data and/or the pointer pointing to the data to the one or more destination applications according to the destination application identifier. The method may also include providing a return code for the one or more destination applications to return status information to the source application.

The method may also include packing a reply, from the one or more destination applications, in a second Ethernet frame. The method may also include modifying a message identifier of the Ethernet frame to generate a modified message identifier to be included in the second Ethernet frame. The method may also include sending the second Ethernet frame from the one or more destination applications to the source application. The method may also include placing the reply in a message queue of the source application if the source application receives the reply.

The features and advantages of the present invention may be better understood with reference to the figures and discussions that follow.

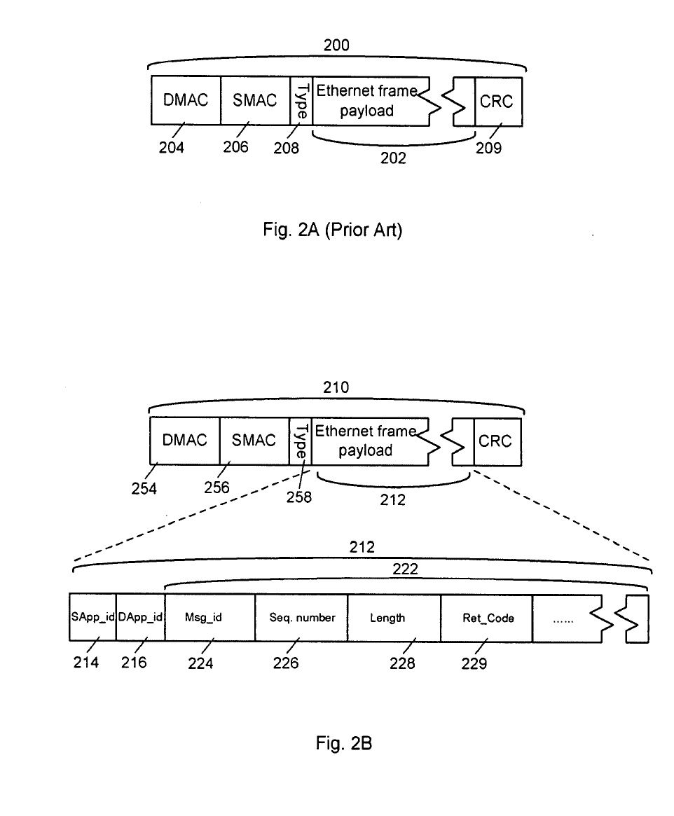

FIG. 2A illustrates an Ethernet frame 200. As illustrated in FIG. 2A, Ethernet frame 200 may include a destination MAC address 204 (DMAC 204), a source MAC address 206 (SMAC 206), a type 208, an Ethernet frame payload 202, and a cyclic redundancy check 109 (CRC 209), described as follows.

DMAC 204 is typically a 48-bit (6 byte/6 octets) field that specifies the port MAC address of the station or stations to which an Ethernet frame payload 202 carried by Ethernet frame 200 should be sent. Each station examines this field to determine whether to accept Ethernet frame payload 202.

SMAC 206 is typically a 48-bit (6 byte/6 octets) field that contains the unique port MAC address of the station that transmits Ethernet frame payload 202.

Type 208 is typically a 16-bit (2 byte/2 octets) field that identifies a higher-level protocol associated with Ethernet frame payload 202. Type 208 may be interpreted at the data link level.

Ethernet frame payload 202 is a data field that may generally contain 46 to 1500 bytes. Each octet (8-bit field) may contain any arbitrary sequence of values. The data field may contain information received from Layer 3 (the Network Layer). The information received from Layer 3 may be broken into frames of information of 46 to 1500 bytes by Layer 2.

CRC 209 is a 32-bit error checking field. CRC 209 is generated based on the DMAC 204, Type 208, and Ethernet frame payload 202.

FIG. 2B illustrates, in accordance with one or more embodiments of the present invention, an Ethernet frame 210 for facilitating communication and management for an EPON system. In Ethernet frame 210, DMAC 254 may specify the port MAC address of an OLT, an ONU, or ONUs to which an Ethernet frame payload 212 carried by Ethernet frame 210 should be sent. SMAC 256 may contain the unique port MAC address of an OLT or ON-U that is transmitting Ethernet frame payload 212. Type 258 may indicate that Ethernet frame 210 represents a proprietary Ethernet frame type.

In Ethernet frame 210, Ethernet frame payload 212 may be significantly different from Ethernet payload 202 of typical Ethernet frame 200 shown in FIG. 2A. Ethernet frame payload 212 includes a source application identifier 214 (SApp_id 214), a destination application identifier 216 (DApp_id 216), and an application payload 222, described as follows.

SApp_id 214 may be a 1-byte field/identifier that identifies a source application (such as a master application in a master-slave architecture) that sends a message (or data) to another application (such as a slave application in a master-slave architecture).

DApp_id 216 may be a 1-byte field/identifier that identifies a destination application (such as a slave application). In an embodiment, a value of 0xff for DApp_id 216 represents all applications in a destination node, such as an OLT, an ONU, or a plurality of ONUs.

Application payload 222 may include message identifier 224 (msg_id 224), sequence number 226, length 228, and return code 229 (ret_code 229), described as follows. Application payload 222 may also include data pertaining to content of one or more messages.

Msg_id 224 may be a 2-byte field that represents an application level message identifier. In an embodiment, the first byte represents operation, with even numbers representing one or more requests and odd numbers representing one or more replies. For example, 0 represents “get”; 1 represents “get reply”; 2 represents “set”; 3 represents “set reply”; 4 represent “delete”; 5 represents “delete reply”; 6 represents “enable”; 7 represents “enable reply”. The second byte specifies which object and/or attribute is to be operated on by the destination application. For example, the second byte may represent VLAN ID, VLAN mode, VLAN member, port rate limit, port priority, authentication information, system information, or image information. In an embodiment, each application may define msg_id 224 alone or with peers of the application.

Sequence number 226 may be a 2-byte field that represents an application level message sequence number generated by an application to correlate a request and a reply.

Length 228 may be a 2-byte field that represents an application level payload length in bytes, e.g., the number of bytes in application payload 222, for enabling an application to interpret the message contained in application payload 222.

Ret_code 229 (return code 229) may be a 2-byte field for a slave application (or destination application) to return a status to a master application (or source application) in master-slave architecture. In an embodiment, ret_code 229 may be valid only in a reply message.

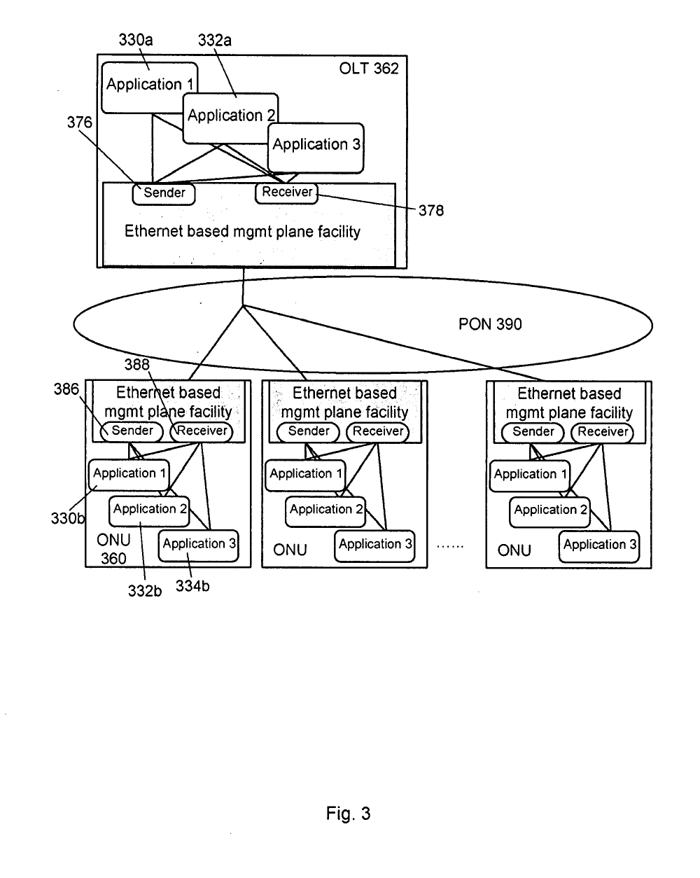

FIG. 3 illustrates, in accordance with one or more embodiments of the present invention, system software architecture of an EPON system. In one or more embodiments, applications in OLT 362, such as application 330a and application 332a, may communicate with applications in intelligent ONU 360, such as applications 330b, 332b, and 334b, through messages/data contained in Ethernet frame 210 illustrated in the example of FIG. 2B. Applications 330a and 332a may reside in at least one of an OLT host CPU (e.g., similar to OLT host CPU 134 illustrated in the example of FIG. 1), a third-party chipset (e.g., similar to third-party chipset 111 illustrated in the example of FIG. 1), and a storage device in OLT 362. Applications 330b, 332b, and 334b may reside in at least one of an ONU host CPU (such as OLT host CPU 104 shown in FIG. 1), a third-party chipset (such as third-party chipset 106 shown in FIG. 1), and a storage device in intelligent ONU 360.

Each of the above-mentioned applications may be a master application that sends messages/data to one or more slave applications to request the one or more slave applications to perform a certain task(s). Each of the above-mentioned applications may also be a slave application that may perform a certain task(s) in response to a request from a master application. A slave application may send a message in reply to the master application. A slave application of a master application may or may not be a peer of the master application. For example, application 330a may send a message to application 330b, a peer of application 330a; application 330a may also send a message to application 332b, which is not a peer of application 330A. A message may contain at least one of a request and a reply. Both request and reply messages may be sent from OLT 362 to intelligent ONU 360, from intelligent ONU 360 to OLT 362, or within an OLT or ONU. A source application that sends a message may be identified by SApp_id 214 (illustrated in the example of FIG. 2B). A destination application that receives a message may be identified by DApp_id 216 (illustrated in the example of FIG. 2B).

In one or more embodiments, the messages may be processed by one or more senders and/or receivers, such as one or more of a sender 376 (in OLT 362), a receiver 378 (in OLT 362), a sender 386 (in intelligent ONU 360), and a receiver 388 (in intelligent ONU 360). A sender may represent a process or program that is configured to collect data/messages from applications residing in the OLT or ONU where the sender resides, pack the data/messages in Ethernet frame 210 (shown in FIG. 2B), and then send Ethernet frame 210 (containing the data/messages) through PON 390. A receiver may represent a process or program that is configured to receive Ethernet frame 210, unpack Ethernet frame 210 to obtain the messages, and dispatch the messages to destination applications residing in the OLT or ONU where the receiver resides.

In one or more embodiments, a sender may provide one or more application interfaces (APIs) to other processes or programs for transmitting data/messages in an asynchronized (or asynchronous) mode or a synchronized (or synchronous) mode.

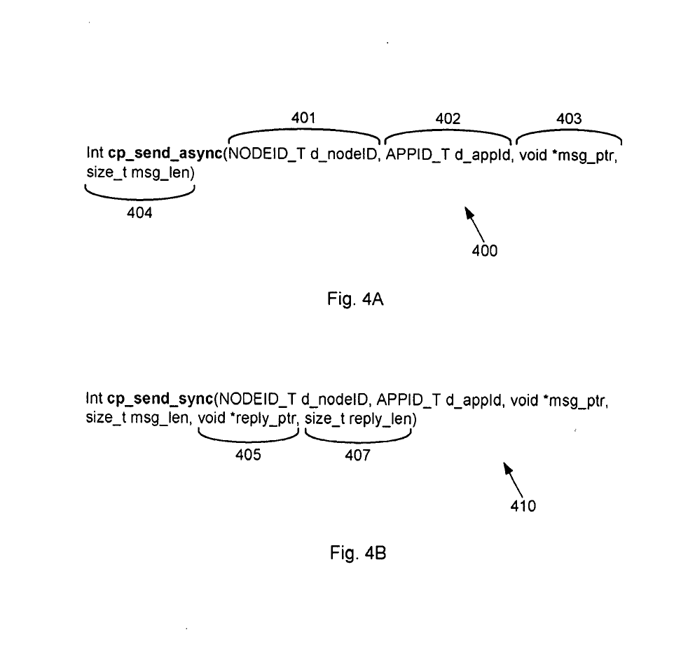

FIG. 4A illustrates, in accordance with one or more embodiments of the present invention, an application interface (API) function 400 for transmitting a message in an asynchronized (or asynchronous) mode. In an embodiment, API function 400 may be provided by a sender.

As illustrated in the example of FIG. 4A, API function 400 includes the following parameters: NODEID_T d_nodeId 401, APPID_T_d_appId 402, void *msg_ptr 403, and size_t msg_len 404, described as follows.

NODEID_T d_nodeID 401 may represent a logical identification for a destination node such as, for example, an OLT or ONU where a destination application resides. NODEID_T d_nodeID 401 does not have to represent a MAC address.

APPID_T d_appId 402 may represent a logical identification for a destination.

Void *msg_ptr 403 may represent a pointer that points to an application payload (or message/data), for example, application payload 222 (illustrated in the example of FIG. 2B). For example, void *msg_ptr 403 may point to a starting byte of application payload 222 or to msg_id 224 (illustrated in the example of FIG. 2B).

Size_t msg_len 404 may represent size or length information pertaining to a message such as, for example, length 228 of application payload 222 (shown in FIG. 2B) or length of Ethernet frame payload 212 (shown in FIG. 2B).

When a sender sends a message, Void *msg_ptr 403 and Size_t msg_len 404 may specify the content of the message, and NODEID_T d_nodeID 401 and APPID_T d_appId 402 may specify the destination for the message.

In one or more embodiments, in the asynchronized (or asynchronous) mode, a source application may not expect (immediate) replies from destination applications. If there are (immediate) replies from the destination applications, the source application will place the (immediate) replies into the message queue of the source application.

FIG. 4B illustrates, in accordance with one or more embodiments of the present invention, an API function 410 for transmitting a message in a synchronized (or synchronous) mode. In the synchronized (or synchronous) mode, a master application which has sent a request message may expect a reply message from a slave application. Therefore, as illustrated in the example of FIG. 4B, in addition to parameters of API 400 (shown in FIG. 4B), API function 410 may further include parameters such as void *reply_ptr 405 and size_t reply_len 407. Void *reply_ptr 405 may represent a pointer that points to (the starting byte of) a reply message. Size_t reply_len 407 may represent size or length information pertaining to the reply message. Accordingly, void *reply_ptr 405 and size_t reply_len 407 may specify the content of the reply the message.

In the synchronized (or synchronous) mode, a master application may call API function 410 to send a message to a slave application. In one or more embodiments, the slave application may send the message back with a modified message identifier (e.g., add 1 to the value of msg_id 224 illustrated in the example of FIG. 2B), a return code (e.g., ret_code 229 illustrated in the example of FIG. 2B), and other information.

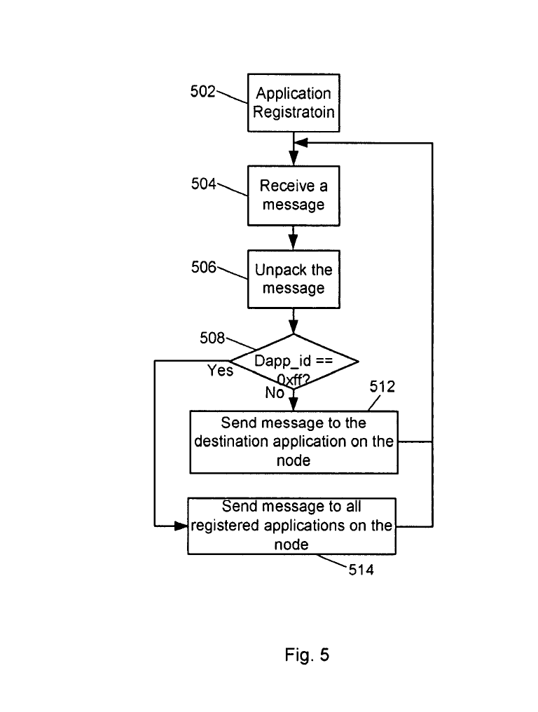

FIG. 5 illustrates, in accordance with one or more embodiments of the present invention, a flowchart of a method for a receiver (such as receiver 388 shown in FIG. 3) to process a message.

The method starts with step 502, at which applications residing in the same node as the receiver may register with the receiver. For example, applications 330b, 332b, and 334b (shown in FIG. 3) may need to register with receiver 388, for example, with application identifiers or call back functions.

At step 504, the receiver may receive a message in an Ethernet frame, e.g., similar to Ethernet frame 210 illustrated in the example of FIG. 2B.

At step 506, the receiver may unpack the message to access the Ethernet frame payload in the Ethernet frame, e.g., similar to Ethernet frame payload 212 (illustrated in the example of FIG. 2B), which contains DApp_id 216 (illustrated in the example of FIG. 2B).

At step 508, the receiver may determine whether the message is destined to all the applications that have registered with the receiver by assessing the destination application identifier value in the Ethernet frame payload. If the destination application identifier value is 0xff, which represents “all applications”, control is transferred to step 514; if not, control is transferred to step 512.

At step 514, the receiver sends the message (or the Ethernet frame payload or application payload in the message) to all the applications that have registered the receiver through registered application identifiers or call back functions.

At step 512, the receiver sends the message (or the Ethernet frame payload or application payload in the message) to the application specified by the destination application identifier value through the registered application identifier or call back function of the application.

As can be appreciated from the foregoing, embodiments of the invention provide a data link layer (layer 2) protocol that is natural to an EPON system for facilitating communication between an OLT host CPU and ONU host CPUs, thereby facilitating interaction of applications in the EPON system and facilitating management of the EPON system. Advantageously, embodiments of the present invention may eliminate the needs to implement TCP/IP stacks and to assign IP addresses for the OLT and ONUs in order to enable the communication. As a result, implementation and maintenance of the EPON system may be simplified, and IP address resource may be conserved.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. An Ethernet frame for facilitating communication, the Ethernet frame comprising:
a source application identifier representing a source application, the source application residing in at least one of an optical line terminal (OLT) and an optical network unit (ONU) in a passive optical network (PON) system; and
a destination application identifier representing one or more destination applications, the one or more destination applications configured to receive data from the source application.

2. The Ethernet frame of 1 wherein the destination identifier represents all of a plurality of applications in a destination node, the destination node being one of the OLT, the ONU, and a plurality of ONUs.

3. The Ethernet frame of 1 further comprising an application level message identifier having a first byte configured to represent at least one of one or more requests and one or more replies.

4. The Ethernet frame of 3 wherein the application level message identifier further has a second byte configured to specify at least one of an object and an attribute for the one or more destination applications to operate on.

5. The Ethernet frame of 1 further comprising a return code configured for the one or more destination applications to return status information to the source application.

6. A passive optical network system (PON system) comprising:
an optical network unit (ONU); and
an optical line terminal (OLT) configured to communicate with the ONU using an Ethernet frame, the Ethernet frame including at least a source application identifier and a destination application identifier, the source application identifier representing a source application residing in at least one of the OLT and the ONU, the destination application identifier representing one or more destination applications configured to receive data from the source application.

7. The PON system of 6 further comprising a sender program residing in the at least one of the OLT and the ONU, the sender program configured to pack the data in the Ethernet frame, the sender program further configured to send the Ethernet frame through a passive optical network.

8. The PON system of 7 wherein the sender is further configured to provide an application interface for the source application to transmit the data in an asynchronized mode, the source application configured to place a reply from the one or more destination applications in a message queue of the source application if the source application receives the reply from the one or more destination applications.

9. The PON system of 7 wherein the sender is further configured to provide an application interface for the source application to transmit the data and for the one or more destination applications to send a reply to the source application, the reply contained in a second Ethernet frame having a modified message identifier that is modified based on a message identifier of the Ethernet frame.

10. The PON system of 7 wherein the sender is further configured to provide an application interface for the source application to transmit the data, the application interface including at least a pointer pointing to at least one of an application payload and an application level message identifier in the Ethernet frame.

11. The PON system of 6 further comprising a receiver program configured to unpack the Ethernet frame to obtain at least one of the data and a pointer pointing to the data, the receiver program further configured to dispatch one or more of the data and the pointer pointing to the data to the one or more destination applications.

12. The PON system of 6 wherein the Ethernet frame further includes at least an application level message identifier, the application level message identifier having a first byte configured to represent at least one of one or more requests and one or more replies.

13. The PON system of 12 wherein the application level message identifier further has a second byte configured to specify at least one of an object and an attribute for the one or more destination applications to operate on.

14. The PON system of 6 wherein the Ethernet frame further includes at least a return code configured for the one or more destination applications to return status information to the source application.

15. A method for facilitating communication between an optical line terminal (OLT) and optical network unit (ONU) in a passive optical network (PON) system, the method comprising:
receiving data from a source application, the source application residing in at least one of the OLT and the ONU;
packing the data in an Ethernet frame, the Ethernet frame including at least a source application identifier representing the source application, the Ethernet frame further including at least a destination application identifier representing one or more destination applications;
sending the Ethernet frame;
unpacking the Ethernet frame to obtain at least one of the data and a pointer pointing to the data; and
dispatching one or more of the data and the pointer pointing to the data to the one or more destination applications according to the destination application identifier.

16. The method of 15 further comprising determining wherein the destination identifier represents all applications registered with a receiver in a destination node, the destination node being one of the OLT, the ONU, and a plurality of ONUs.

17. The method of 15 wherein the destination identifier represents all of a plurality of applications in a destination node, the destination node being one of the OLT, the ONU, and a plurality of ONUs.

18. The method of 15 further comprising providing a return code for the one or more destination applications to return status information to the source application.

19. The method of 15 further comprising placing a reply from the one or more destination applications in a message queue of the source application if the source application receives the reply from the one or more destination applications.

20. The method of 15 further comprising:
packing a reply in a second Ethernet frame;
modifying a message identifier of the Ethernet frame to generate a modified message identifier to be included in the second Ethernet frame; and
sending the second Ethernet frame from the one or more destination applications to the source application.
